(19) United States
(12) Patent Application Publication
(10) Pub. No.: US 2009/0081400 A1
(43) Pub. Date: Mar. 26, 2009

(54) Sandwich Component Assembly with An L-Shaped Or T-Shaped Element, And Method For Production Of Such Assemblies

(75) Inventors: Christian Wolf, Neu-Ulm (DE); Oleg Graf, Tiefenbach (DE); Valentin German, Schnurpflingen (DE)

Correspondence Address: WOOD, HERRON & EVANS, LLP, 2700 CAREW TOWER, 441 VINE STREET, CINCINNATI, OH, 45202, US

(73) Assignee: Airbus Deutschland GmbH, Hamburg (DE)

(21) Appl. No.: 12/201,219

(22) Filed: Aug. 29, 2008

Related U.S. Application Data
(60) Provisional application No. 60/969,206, filed on Aug. 31, 2007.

(30) Foreign Application Priority Data
Aug. 31, 2007 (DE) DE102007041282.9

(51) Int. Cl. B32B 3/12; B32B 37/00

(52) U.S. Cl. 428/57; 156/307.1

(57) ABSTRACT

A sandwich component assembly (10) with an L-shaped element comprises a first sandwich panel (12) with a first honeycomb core (14), the upper and lower sides of which are provided with respective cover layers (16, 18), one of which cover layers forms an inner cover layer (16) and the other cover layer an outer cover layer (18), and a second sandwich panel (20) with a second honeycomb core (22), the upper and lower sides of which are provided with respective cover layers (24, 26), one of which cover layers likewise forms an inner cover layer (26) and the other cover layer an outer cover layer (24). At least one edge of the second sandwich panel (20) is connected to the first sandwich panel (12) to form an L-shaped element. In order to increase joint strength and to save weight, on the one hand the inner cover layer (16) of the first sandwich panel (12) is connected in an overlapping fashion to the inner cover layer (26) of the second sandwich panel (20) and, on the other, the outer cover layer (18) of the first sandwich panel (12) is connected in an overlapping fashion to the outer cover layer (24) of the second sandwich panel (20), in the connection zone between the first sandwich panel (12) and the second sandwich panel (20). In addition, a layer of expanding adhesive (32) is arranged between each edge of the second sandwich panel (20) which is connected to the first sandwich panel (12), and the first sandwich panel (12).

The invention relates to a sandwich component assembly with an L-shaped or T-shaped element and to a method for production of such an assembly.

Sandwich panels consisting of a honeycomb core provided with thin-walled skins are characterized by high stiffness and flexural strength combined with low weight. Because of these properties, sandwich panels are used in many technical fields, for example aircraft construction, vehicle construction, aerospace and building construction. Sandwich panels are especially important for the interior fittings of aircraft, for example. Thus, in present-day commercial aircraft the walls of the luggage stowage systems in the passenger cabins of aircraft, usually in the form of overhead luggage compartments, are made of sandwich panels in which a honeycomb core of paper cells impregnated with synthetic resin is arranged between two cover sheets or cover layers of glass fiber-reinforced and/or carbon fiber-reinforced composite laminates impregnated with synthetic resin. Sandwich panels or sandwich components configured in this manner are very light yet stable. However, in the pursuit of overall weight reduction of aircraft there is a desire to make such sandwich components even lighter than hitherto without impairing their stability in practical use.

The load-bearing parts of a sandwich panel are the cover layers. The honeycomb core of a sandwich panel acts as a shear-resistant web and maintains the two cover layers of composite laminate at a distance from one another. The honeycomb core therefore transmits transverse forces and its shear strength makes a considerable contribution to the strength of the whole sandwich panel As already mentioned, however, the main load is borne by the cover layers, also referred to as skins. If a bending load is to be applied to a sandwich panel, one cover layer of the sandwich panel is loaded in tension and the other in compression. Only if the complete sandwich structure can be maintained over the whole contour of a component is the strength of the whole component preserved. To make this possible, every necessary contour change must have smooth transitions with large radii, which, however, will not always be possible. For example, if a contour with a 90° deflection, i.e. with a very small radius or no radius at all, is required, the sandwich panel is usually severed at this position and reconnected to the remaining part of the sandwich panel with a butt joint or a dovetail joint. In the case of a corner between planes, a joining method referred to as zipper bonding is frequently used. In this method the sandwich panels are provided at the edges to be joined with tabs of large width which interlock in a concealed manner in the finished joint. For T-shaped connections between two sandwich panels a so-called “tongue-and-groove” method is used, in which a straight, concealed mortise-and-tenon joint with very wide tenons is used to connect the planes.

In order to ensure a strong connection between two sandwich panels connected by either an L-shaped or a T-shaped joint, the cells of the honeycomb core in the connection zone are usually filled with adhesive and the edges of the two sandwich panels to be joined are butt-joined and cured in the composite. Another possibility is to fill the cells of the honeycomb core in the connection zone with a core-filling composition and, after curing of the latter, to screw the two sandwich panels together using special fixing elements. The disadvantage of this procedure is an inherent reduction in strength resulting from the severing of the cover layers, and a significant increase in weight because of the adhesive or core-filling composition used for filling the cavities in the connection zone. Further disadvantages result from the multi-step nature of the manufacturing process, since the sandwich panels must first be produced in finished form and can only then be joined to one another in the required geometry. Because of the repeated curing operations with long curing times which they entail, these methods increase the cost of series production.

It is the object of the invention to provide an improved technique by which transitions with very small radii, or no radii, between sandwich panels can be achieved, these transitions, i.e. the connection zones, being of light weight yet high strength. In the context of the present description the term “connection zone” means the actual connection site between two (or more) sandwich panels and the zones adjacent to this connection site of the sandwich panels connected to one another at the connection site.

This object is achieved according to the invention with a sandwich component assembly with an L-shaped element having the features specified in claim 1. More precisely, the sandwich component assembly with an L-shaped element consists of a first sandwich panel with a first honeycomb core, the upper and lower sides of which are each covered with a cover layer, one of which cover layers forms an inner cover layer and the other an outer cover layer, and of a second sandwich panel with a second honeycomb core, the upper and lower sides of which are also each provided with a cover layer, one of which again forms an inner cover layer and the other an outer cover layer. At least one edge of the second sandwich panel is connected to the first sandwich panel to form the desired L-shaped element.

For light yet strong connection of the two sandwich panels, on the one hand the inner cover layer of the first sandwich panel is connected in an overlapping fashion to the inner cover layer of the second sandwich panel and, on the other, the outer cover layer of the first sandwich panel is connected in an overlapping fashion to the outer cover layer of the second sandwich panel, in the connection zone between the first sandwich panel and the second sandwich panel. In addition, a layer of expanding adhesive is arranged between each edge of the second sandwich panel which is connected to the first sandwich panel, and the first sandwich panel. This expanding adhesive, which may be inserted, for example, in the form of a thin strip, expands during curing with the application of heat and fills all the gaps in the corner connection between the two sandwich panels. Because of the overlapping connection of the cover layers of the two sandwich panels in the connection zone, the force-transmitting capacity of the cover layers is preserved even in the connection zone, whereby the strength of the overall component is significantly improved practically without an increase in weight. The edge or edges of the second sandwich panel may be butt-joined to the first sandwich panel (or further sandwich panels). Alternatively, it is possible to dovetail together the honeycomb cores of the sandwich panels to be connected in the connection zone.

According to an embodiment, the outer cover layer of the first sandwich panel is brought up in the connection zone between the first sandwich panel and the second sandwich panel and connected in an overlapping fashion to the outer cover layer of the second sandwich panel, while the outer cover layer of the second sandwich panel may be arranged above or below the outer cover layer of the first sandwich panel. It is also possible for the outer cover layer of the second sandwich panel to be brought down, that is, to be formed longer and passed above or below the outer cover layer of the first sandwich panel.

According to an embodiment, the inner cover layer of the second sandwich panel is brought down in the connection zone between the first sandwich panel and the second sandwich panel and connected in an overlapping fashion to the inner cover layer of the first sandwich panel. In this case the inner cover layer of the second sandwich panel may be located, in the overlap zone, above or below the inner cover layer of the first sandwich panel.

The edge of the second sandwich panel to be connected to the first sandwich panel may be butt-joined to the first sandwich panel. In such a case, according to a preferred embodiment, the outer cover layer of the second sandwich panel is extended beyond the second honeycomb core and largely covers the edge of the first honeycomb core located in the connection zone. In this way, in the finished sandwich component assembly, a connection is produced between the part of the outer cover layer of the second sandwich panel extending beyond the second honeycomb core and the edge of the first honeycomb core located in the connection zone, increasing the strength of the overall connection. Furthermore, in this way the amount of overlap between the two outer cover layers can be enlarged, which also leads to an increase in the strength of the connection.

According to a preferred embodiment, in the case of butt-joined sandwich panels the inner cover layer of the first sandwich panel extends alternatively or additionally below the edge of the second sandwich panel located in the connection zone, so that it at least largely covers the edge of the second honeycomb core. In such an embodiment the layer of expanding adhesive is arranged between the inner cover layer of the first sandwich panel and the edge of the second honeycomb core.

Alternatively to the butt-joining of two sandwich panels, according to another embodiment the edges of the first honeycomb core and of the second honeycomb core located in the connection zone are each chamfered, preferably with a chamfer of 45°.

The amount of overlap between the outer cover layers and/or between the inner cover layers does not depend on which cover layer is arranged above the respective other cover layer and, in a preferred configuration, is approximately 20 mm in each case. Self-evidently, the amount of overlap may be selected smaller or larger if this seems appropriate for reasons of strength.

According to a further aspect of the invention, the object stated in the introduction is further achieved with a sandwich component assembly with a T-shaped element having the features specified in claim 10. More precisely, the sandwich component assembly with a T-shaped element consists of a first sandwich panel with a first honeycomb core, the upper and lower sides of which are each provided with a cover layer, and of a second sandwich panel with a second honeycomb core, the upper and lower sides of which are also each provided with a cover layer. At least one edge of the second sandwich panel is connected to the first sandwich panel to form the desired T-shaped element.

For light yet strong connection of the two sandwich panels, the cover layer of the first sandwich panel oriented towards the second sandwich panel is connected in an overlapping fashion to the cover layers of the second sandwich panel in the connection zone between the first sandwich panel and the second sandwich panel, hereinafter referred to only as the connection zone. In addition, a layer of expanding adhesive is arranged between each edge of the second sandwich panel which is connected to the first sandwich panel, and the honeycomb core of the first sandwich panel. This expanding adhesive, which may be inserted, for example, in the form of a thin strip, expands during curing with the application of heat and fills all the gaps in the corner connection between the two sandwich panels. Because of the overlapping connection of the cover layers of the two sandwich panels in the connection zone, the force-transmitting capacity of the cover layers is preserved even in the connection zone, significantly improving the strength of the overall component practically without an increase in weight. The edge or edges of the second sandwich panel may be butt-joined to the first sandwich panel (or further sandwich panels). Alternatively, it is possible for the honeycomb cores of the sandwich panels which are to be connected to one another to be dovetailed together in the connection zone.

According to an embodiment, the cover layer of the first sandwich panel oriented towards the second sandwich panel is brought up in the connection zone and connected in an overlapping fashion to the cover layers of the second sandwich panel, in which case the cover layers of the second sandwich panel may be arranged above or below the cover layer of the first sandwich panel. It is also possible for the cover layers of the second sandwich panel to be brought down, that is, to be formed longer and to be passed above or below the cover layer of the first sandwich panel in the connection zone. The amount of overlap does not depend on whether the cover layer of the first sandwich panel is brought up in the direction of the second sandwich panel, or the cover layers of the second sandwich panel are brought down in the direction of the first sandwich panel, and, in a preferred configuration, is approximately 20 mm. Self-evidently, the amount of overlap may be selected larger or smaller if this seems appropriate for reasons of strength.

To further increase the strength of the connection zone, in preferred configurations of the sandwich component assembly according to the invention a reinforcing cover layer is arranged between each edge of the second sandwich panel which is connected to the first sandwich panel, and the first honeycomb core, which reinforcing cover layer is connected in an overlapping fashion to the cover layer of the first sandwich panel oriented towards the second sandwich panel. The layer of expanding adhesive is then located between the reinforcing cover layer and the respective edge of the second sandwich panel. With this additional reinforcing cover layer, a continuous connection of the cover layer of the first sandwich panel is established not only to the cover layers of the second sandwich panel but also within the cover layer of the first sandwich panel itself. The total structure is characterized by high bending stiffness, since the cover layers are interrupted neither on the inside nor on the outside and the honeycomb connection is executed in a shear-resistant manner by means of the expanding adhesive. Here, too, the overlap of the reinforcing cover layer with the cover layer of the first sandwich panel oriented towards the second sandwich panel is preferably approximately 20 mm on both sides of the second sandwich panel.

The honeycomb cores of the sandwich panels are preferably substantially planar and consist preferably of synthetic resin-impregnated paper cells which optionally may be reinforced with aramide fibers. The paper cells preferably have a right-angled or hexagonal cross section.

The object stated in the introduction is also achieved by a method for producing a sandwich component assembly with an L-shaped element which comprises the following steps:
provision of a first honeycomb core and of a second honeycomb core for connection thereto,
arrangement of a layer of expanding adhesive between an edge of the second honeycomb core and the first honeycomb core,
arrangement of an inner cover layer and an outer cover layer on the first honeycomb core and arrangement of an inner cover layer and an outer cover layer on the second honeycomb core, in such a manner that the outer cover layers and the inner cover layers overlap in the connection zone between the first honeycomb core and the second honeycomb core, and
heat treatment of the assembly obtained, for connecting together and curing the first honeycomb core and the second honeycomb core and the cover layers. If cold-curing resins are used, the heat treatment may be omitted; the curing step then takes place at ambient temperature.

The object stated in the introduction is achieved, finally, by a method for producing a sandwich component assembly with a T-shaped element comprising the following steps:
provision of a first honeycomb core and of a second honeycomb core for connection thereto,
arrangement of a layer of expanding adhesive between an edge of the second honeycomb core and a side face of the first honeycomb core,
arrangement of a cover layer on the side of the first honeycomb core oriented towards the second honeycomb core and arrangement of cover layers on both sides of the second honeycomb core in such a manner that the cover layers of the second honeycomb core overlap with the cover layer of the first honeycomb core in the connection zone between first honeycomb core and second honeycomb core, and
heat treatment of the assembly obtained, for connecting together and curing the first honeycomb core and the second honeycomb core and the cover layers. If cold-curing resins are used, the heat treatment may be omitted; the curing step then takes place at ambient temperature.

Unlike the conventional method, the method according to the invention permits the production of a sandwich component assembly with L-shaped or T-shaped elements in a single process, since finished sandwich panels, that is, sandwich panels already provided with cover layers, do not serve as the starting material, as hitherto, but only the honeycomb cores. The cover layers are then applied to the L-shaped or T-shaped assembly and connected to one another in the manner described, whereby, in addition to a significant saving of production time, the lighter yet stronger connection between the sandwich panels already described is obtained. The heat treatment step is preferably carried out in an autoclave, especially preferably with combined application of pressure below and above atmospheric.

Sandwich component assemblies produced according to the invention are significantly lighter, since honeycomb core-filling composition is no longer required and the quantity of adhesive is drastically reduced. The composite strength in the connection zone is, at most, slightly reduced in comparison to a normal sandwich panel, and fracture of the component assembly as a result of honeycomb core failure no longer occurs in practice, as the cover layers are connected to one another in a planar manner in the connection zone. Complicated geometries with sharp transitions between the individual sandwich panels can be produced with outstanding strength properties and in a weight-optimized manner.

Self-evidently, the present invention is not restricted to purely L-shaped or T-shaped sandwich component assemblies, but any combination of L-shaped and/or T-shaped elements may also be used, for example rectangular assemblies, double-T assemblies and the like. It is also self-evident that, in the case of an L-shaped assembly, the lengths of the arms of the L may be equal or unequal.

Exemplary embodiments of the present invention are explained in more detail below with reference to the appended, schematic figures, together with further advantages. In the drawings:

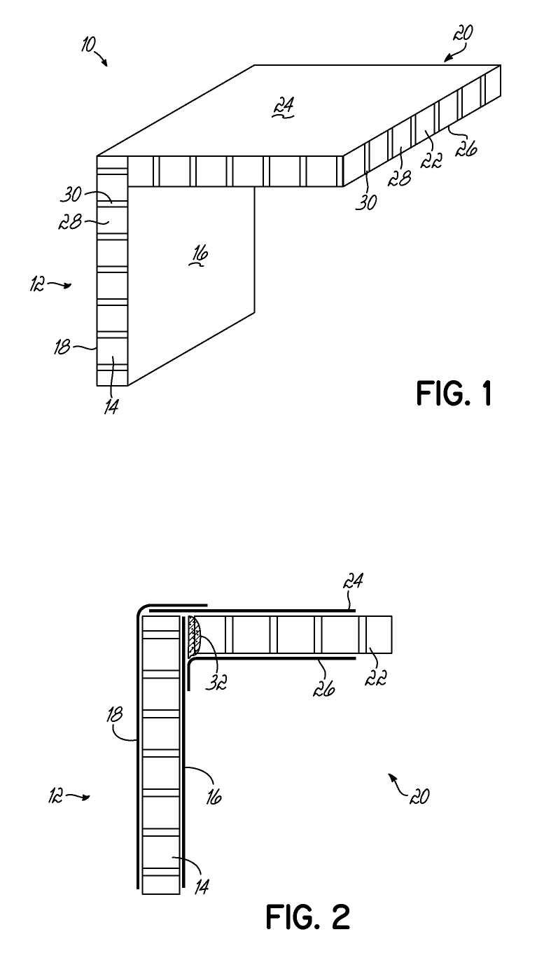

FIG. 1 shows a first exemplary embodiment of an L-shaped sandwich component assembly in a three-dimensional representation;

FIG. 2 shows a section through the sandwich component assembly of FIG. 1, in which details of the connection zone between the two sandwich panels can be seen;

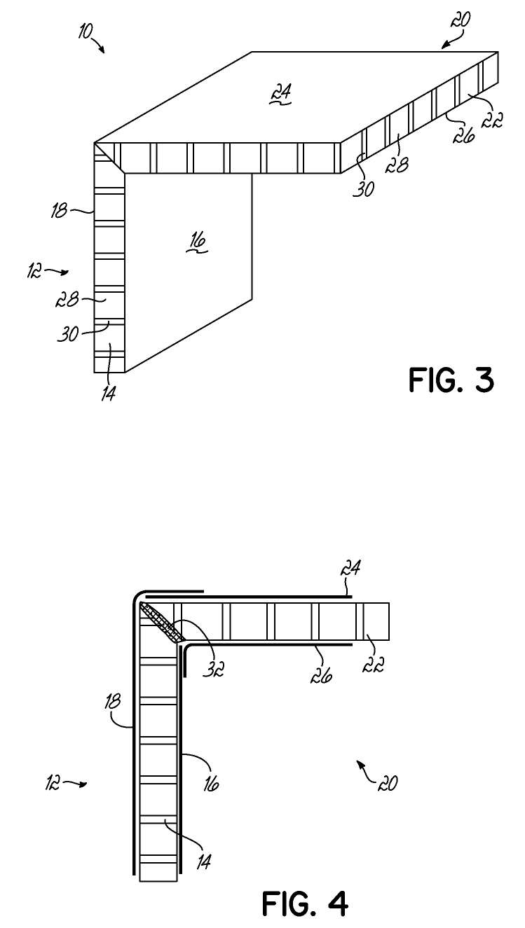

FIG. 3 shows a second exemplary embodiment of an L-shaped sandwich component assembly in a three-dimensional representation;

FIG. 4 shows a section through the sandwich component assembly of FIG. 3, in which details of the connection zone between the two sandwich panels can be seen;

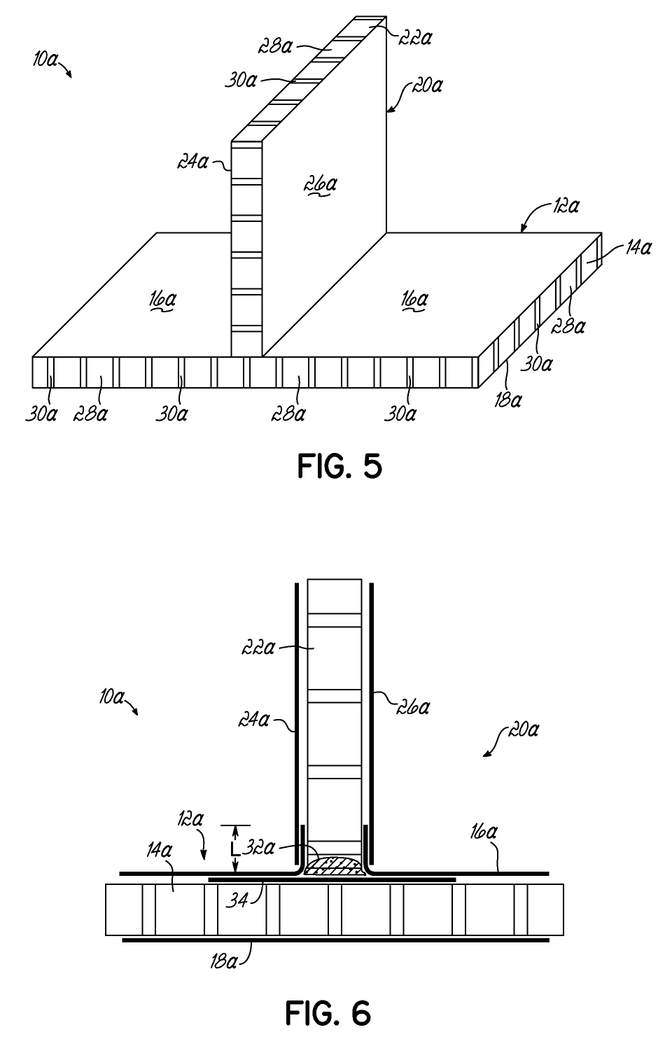

FIG. 5 shows a T-shaped sandwich component assembly in a three-dimensional representation, and

FIG. 6 shows a section through the sandwich component assembly of FIG. 5, in which details of the connection zone between the two sandwich panels can be seen.

FIG. 1 shows schematically and in a three-dimensional representation an L-shaped sandwich component assembly denoted as a whole by 10. The assembly 10 includes a first sandwich panel 12 with a first honeycomb core 14, the upper side of which is provided with a cover layer 16 and the lower side of which is covered with a cover layer 18.

In addition, the assembly 10 includes a second sandwich panel 20 with a second honeycomb core 22, which is also skinned on both sides with cover layers 24, 26. Because the cover layers 16 and 26 are located on the inner side of the L-shaped sandwich component assembly 10, the cover layer 16 is referred to as the inner cover layer of the first sandwich panel 12 and the cover layer 26 as the inner cover layer of the second sandwich panel 20. Similarly, the cover layer 18 is referred to as the outer cover layer of the first sandwich panel 12 and the cover layer 24 as the outer cover layer of the second sandwich panel 20. The cover layers 16, 18, 24 and 26, which are also referred to as skins, are usually thin-walled, glass fiber-reinforced or carbon fiber-reinforced composite laminates impregnated with resin. The honeycomb cores 14 and 22 consist of resin-impregnated paper cells which are optionally reinforced with aramide fibers. The sandwich panels 12 and 20 are shown cut through along the edges and individual cells 28 of the honeycomb cores 14 and 22, and partitions 30 separating these cells 28 from one another, are indicated.

A sandwich component assembly 10 as illustrated may, for example, form part of the fittings of a passenger cabin of a commercial aircraft. Such an assembly 10 may also find application in the interior fittings of, for example, a cruise liner or a railway train.

The connection between the two sandwich panels 12 and 20 is explained in more detail below with reference to FIG. 2. The starting point of the L-shaped sandwich component assembly 10 comprises the first honeycomb core 14 and the second honeycomb core 22. The inner cover layer 16 is first arranged on the first honeycomb core 14, extending in the exemplary embodiment illustrated as far as the edge of the first honeycomb core 14, that is, under the edge region of the second sandwich panel 20 which is to be connected to the first sandwich panel 12.

A layer of expanding adhesive 32, advantageously in the form of a strip with at least approximately the same width as that of the edge of the second honeycomb core 22 oriented towards the first sandwich panel 12, is then arranged on the surface of the cover layer 16 oriented towards the second honeycomb layer 22. This layer of expanding adhesive 32 extends over a length at least equal to the length of the edge of the second honeycomb core 22 which is to be connected to the first honeycomb panel 12.

The edge of the second honeycomb core 22 can now be placed on the layer of expanding adhesive 32. Alternatively, this expanding adhesive 32 may also have been applied previously to the corresponding edge of the second honeycomb core 22.

The outer cover layer 24 and the inner cover layer 26 are then arranged on the second honeycomb core 22, the outer cover layer 24 extending beyond the edge of the honeycomb core 22 and covering as far as possible the adjacent edge of the first honeycomb core 14. The inner cover layer 26 is also prolonged and brought down on to the inner cover layer 16 in order to form an overlap area with the latter.

Finally, the outer cover layer 18 is arranged on the lower side of the honeycomb core 14 and brought around the corner into overlap with the outer cover layer 24. Alternatively, instead of the cover layer 18 the cover layer 24 may be brought around the corner into overlap with the cover layer 18. In the exemplary embodiment shown, the cover layer 18 is arranged above the cover layer 24; however, this may also be reversed.

The assembly of components prepared in this way is now introduced into a heated autoclave for curing, the curing process being carried out with the combined application of pressure below and above atmospheric. In this case the components of the sandwich structure are first placed successively one above the other on a half-tool and then covered with a tear-off textile, a perforated film, a suction fleece and a vacuum film in order to be able to evacuate the space below the vacuum film in which the sandwich structure is located. The space below the vacuum film is then evacuated to a negative pressure of approximately 0.7 to 0.9 bar, and a positive pressure, for example of 5 to 8 bar, is built up in the interior of the autoclave. The pressure difference acting on the sandwich structure in this way presses the individual layers firmly into the geometry of the tool. This production method is well-known to specialists in the field and therefore does not need to be explained further.

During the curing process, on the one hand the resin-saturated cover layers 16, 18, 24 and 26 are connected to the respective associated honeycomb cores 14, 22 and, on the other, the respective cover layers 16 and 26, and 18 and 24, are connected to one another in the overlap areas. In addition, the layer of expanding adhesive 32 expands and thereby fills all gaps between the two honeycomb cores 14 and 22 in the connection zone, as well as any cavities which exist on the inside between the cover layers 16, 26 and 24 in the connection zone.

When curing and cooling are completed, the sandwich component assembly 10 obtained is characterized by high bending stiffness as a result of the uninterrupted connection of the cover layers to one another on the inside and the outside. In addition, the expanding adhesive produces a shear-resistant connection between the honeycomb core 22 and the sandwich panel 12.

The second exemplary embodiment shown in FIGS. 3 and 4 differs from the first exemplary embodiment in that the second honeycomb core 22 is not butt-joined to the first sandwich panel 12, but the edge of the honeycomb core 22 to be used for the connection is chamfered at an angle of 45°. In the same way, the edge of the first honeycomb core 14 to be used for the connection is chamfered at 45°, in order to fit the associated edge of the second honeycomb core 22. The layer of expanding adhesive 32 is arranged between these two edges of the honeycomb cores 14 and 22 to be connected. The arrangement of the cover layers 18 and 24, and 16 and 26, corresponds to that of the first exemplary embodiment.

FIG. 5 shows schematically and in a three-dimensional representation a T-shaped sandwich component assembly denoted as a whole by 10a. The assembly 10a includes a first sandwich panel 12a with a first honeycomb core 14a, the upper side of which is provided with a cover layer 16a and the lower side with a cover layer 18a. In addition, the assembly 10a includes a second sandwich panel 20a with a second honeycomb core 22a, which is also skinned on both sides with respective cover layers 24a and 26a. The cover layers 16a, 18a, 24a and 26a, which are also referred to as skins, are usually thin-walled, glass fiber-reinforced or carbon fiber-reinforced resin-impregnated composite laminates. The honeycomb cores 14a and 22a consist of resin-impregnated paper cells which are optionally reinforced with aramide fibers. The sandwich panels 12a and 20a are shown cut-through along the edges and individual cells 28a of the honeycomb cores 14a and 22a, and partitions 30a separating the cells 28a from one another, are indicated.

A sandwich component assembly 10a as illustrated may, for example, form part of the fittings of a passenger cabin of a commercial aircraft. Such an assembly 10a may also find application in the interior fittings of, for example, a cruise liner or a railway train.

The connection between the two sandwich panels 12a and 20a is explained in more detail below with reference to FIG. 6. The starting point for the T-shaped sandwich component assembly 10a comprises the first honeycomb core 14a and the second honeycomb core 22a. A reinforcing cover layer 34 is first arranged on the upper side to of the first honeycomb core 14a, in the region in which the second honeycomb core 22a is later to be attached to the first sandwich panel 12a. This reinforcing cover layer 34 preferably consists of the same material as the cover layer 16a and extends on the upper side of the honeycomb core 14a over a length which at least equals the length of the edge of the second sandwich panel 20a which is to be connected to the first sandwich panel 12a. As can be seen from FIG. 6, the reinforcing cover layer 34 projects beyond the edge of the second sandwich panel 20a on both sides, by approximately 20 mm on each side, in the exemplary embodiment shown.

A layer of expanding adhesive 32a, preferably in the form of a strip with at least approximately the same width as that of the edge of the second honeycomb core 22a oriented towards the first sandwich panel 12a, is then arranged on the surface of the reinforcing cover layer 34 oriented towards the second honeycomb core 22a. This layer of expanding adhesive 32a is attached at the centre of the reinforcing cover layer 34 and extends, like the reinforcing cover layer 34, over a length at least equal to the length of the edge of the second honeycomb core 22a which is to be connected to the first sandwich panel 12a.

The cover layers 16a and 15a are now arranged on the first honeycomb core 14a, the cover layer 16a oriented towards the second honeycomb core 22a on the upper side of the first honeycomb core 14a being brought upwards a certain distance in the connection zone between the sandwich panels 12a, 20a, in order to cover the facing surface of the second honeycomb core 22a. In the exemplary embodiment illustrated, the brought-up portions of the cover layer 16a have a length L of approximately 20 mm.

The cover layers 24a and 26a of the second sandwich panel 20a are then arranged on the honeycomb core 22a in such a manner that their end portions adjacent to the first sandwich panel 12a overlap the brought-up portions of the cover layer 16a (see FIG. 6). In the case illustrated, therefore, in the overlap area of the cover layer 16a with the cover layers 24a and 26a, the latter are arranged over the cover layer 16a. Alternatively, however, this may be reversed, that is, the cover layers 24a and 26a may be arranged first on the honeycomb core 22a and then the cover layer 16a on the honeycomb core 14a, so that the brought-up portions of the cover layer 16a are located over the end portions of the cover layers 24a and 26a. It is also possible not to bring up the cover layer 16a, but to prolong the cover layers 24a and 26a downwardly in order to bring them into overlap with the cover layer 16a. If a reinforcing cover layer 34 is present, however, an increased layer thickness is then produced in this area, which is avoided in the embodiment according to FIG. 6.

Finally, the cover layer 18a is arranged on the lower side of the honeycomb core 14a. This may take place at the end or at any desired earlier time, since the cover layer 18a is not directly involved in the connection between the two sandwich panels 12a and 20a.

The assembly of components thus prepared is now introduced for curing into a heated autoclave, in which the curing process is carried out with combined application of pressure below and above atmospheric. In this case the components of the sandwich structure are first placed successively one above the other on a half-tool and then covered with a tear-off textile, a perforated film, a suction fleece and a vacuum film in order to be able to evacuate the space below the vacuum film in which the sandwich structure is located. The space below the vacuum film is then evacuated to a negative pressure of approximately 0.7 to 0.9 bar, and a positive pressure, for example of 5 to 8 bar, is built up in the interior of the autoclave. The pressure difference acting on the sandwich structure in this way presses the individual layers firmly into the geometry of the tool. This production method is well-known to specialists in the field and therefore does not need to be explained further.

During the curing process, on the one hand the resin-saturated cover layers 16a, 18a, 24a, 26a and 34 are connected to the respective associated honeycomb cores 14a, 22a and, on the other, the cover layers 16a and 34, and 16a and 24a, 26a respectively, are connected to one another in the overlap areas. In addition, the layer of expanding adhesive 32a expands and thereby fills all gaps between the two honeycomb cores 14a and 22a in the connection zone, as well as any cavities which exist on the inside between the cover layers 16a and 34 in the connection zone.

When curing and cooling are completed, the sandwich component assembly 10a obtained is characterized by high bending stiffness as a result of the uninterrupted connection of the cover layers to one another on the inside and the outside. In addition, the expanding adhesive produces a shear-resistant connection between the honeycomb core 22a and the reinforcing cover layer 34.

1. Sandwich component assembly (10) with an L-shaped element, comprising
a first sandwich panel (12) which has a first honeycomb core (14), the upper and lower sides of which are provided with respective cover layers (16, 18), one of which cover layers forms an inner cover layer (16) and the other cover layer an outer cover layer (18),
a second sandwich panel (20) which has a second honeycomb core (22), the upper and lower sides of which are provided with respective cover layers (24, 26), one of which cover layers forms an inner cover layer (26) and the other cover layer an outer cover layer (24), at least one edge of the second sandwich panel (20) being connected to the first sandwich panel (12) to form an L-shaped element, and wherein
on the one hand, the inner cover layer (16) of the first sandwich panel (12) is connected in an overlapping fashion to the inner cover layer (26) of the second sandwich panel (20) and, on the other, the outer cover layer (18) of the first sandwich panel (12) is connected in an overlapping fashion to the outer cover layer (24) of the second sandwich panel (20), in the connection zone between the first sandwich panel (12) and the second sandwich panel (20), and
a layer of expanding adhesive (32) is arranged between each edge of the second sandwich panel (20) which is connected to the first sandwich panel (12), and the first sandwich panel (12).

2. Sandwich component assembly according to claim 1, characterized in that the outer cover layer (18) of the first sandwich panel (12) is brought up and connected in an overlapping fashion to the outer cover layer (24) of the second sandwich panel (20) in the connection zone between the first sandwich panel (12) and the second sandwich panel (20).

3. Sandwich component assembly according to claim 2, characterized in that the outer cover layer (18) of the first sandwich panel (12) is arranged over the outer cover layer (24) of the second sandwich panel (20).

4. Sandwich component assembly according to claim 1, characterized in that the inner cover layer (26) of the second sandwich panel (20) is brought down and connected in an overlapping fashion to the inner cover layer (16) of the first sandwich panel (12) in the connection zone between the first sandwich panel (12) and the second sandwich panel (20).

5. Sandwich component assembly according to claim 1, characterized in that the edges of the first honeycomb core (14) and of the second honeycomb core (22) located in the connection zone are chamfered.

6. Sandwich component assembly according to claim 5, characterized in that the edges of the first honeycomb core (14) and of the second honeycomb core (22), respectively, located in the connection zone have a chamfer of 45 degrees.

7. Sandwich component assembly according to claim 1, characterized in that the outer cover layer (24) of the second sandwich panel (20) is prolonged beyond the second honeycomb core (22) and largely covers the edge of the first honeycomb core (14) located in the connection zone.

8. Sandwich component assembly according to claim 1, characterized in that the inner cover layer (16) of the first sandwich panel (12) extends below the edge of the second sandwich panel (20) located in the connection zone and at least largely covers the edge of the second honeycomb core (22), the layer of expanding adhesive (32) being arranged between the inner cover layer (16) of the first sandwich panel (12) and the edge of the second honeycomb core (22).

9. Sandwich component assembly according to claim 1 characterized in that the amount of overlap between the outer cover layers (18, 24) and/or between the inner cover layers (16, 26), respectively, is approximately 20 mm.

10. Sandwich component assembly (10a) with a T-shaped element, comprising
a first sandwich panel (12a) which has a first honeycomb core (14a), the upper and lower sides of which are provided with respective cover layers (16a, 18a),
a second sandwich panel (20a) which has a second honeycomb core (22a), the upper and lower sides of which are provided with respective cover layers (24a, 26a), at least one edge of the second sandwich panel (20a) being connected to the first sandwich panel (12a) to form a T-shaped element, and wherein
the cover layer (16a) of the first sandwich panel (12a) oriented towards the second sandwich panel (20a) is connected in an overlapping fashion to the cover layers (24a, 26a) of the second sandwich panel (20a) in the connection zone between the first sandwich panel (12a) and the second sandwich panel (20a), and
a layer of expanding adhesive (32a) is arranged between each edge of the second sandwich panel (20a) which is connected to the first sandwich panel (12a), and the honeycomb core (14a) of the first sandwich panel (12a).

11. Sandwich component assembly according to claim 10, characterized in that the cover layer (16a) of the first sandwich panel (12a) oriented towards the second sandwich panel (20a) is brought up and connected in an overlapping fashion to the cover layers (24a, 26a) of the second sandwich panel (20a) in the connection zone between the first sandwich panel (12a) and the second sandwich panel (20a).

12. Sandwich component assembly according to claim 11, characterized in that the cover layers (24a, 26a) of the second sandwich panel (20a) are arranged over the cover layer (16a) of the first sandwich panel (12a).

13. Sandwich component assembly according to claim 11, characterized in that the cover layer (16a) of the first sandwich panel (12a) oriented towards the second sandwich panel (20a) is brought up by approximately 20 mm over the second sandwich panel (20a) in the connection zone between the first sandwich panel (12a) and the second sandwich panel (20a).

14. Sandwich component assembly according to claim 10, characterized in that a reinforcing cover layer (34) is arranged between each edge of the second sandwich panel (20a) which is connected to the first sandwich panel (12a), and the first honeycomb core (14a), which reinforcing cover layer (34) is connected in an overlapping fashion to the cover layer (16a) of the first sandwich panel (12a) oriented towards tie second sandwich panel (20a), the layer of expanding adhesive (32a) being arranged between the reinforcing cover layer (34) and the respective edge of the second sandwich panel (20a).

15. Sandwich component assembly according to claim 14, characterized in that the reinforcing cover layer (34) overlaps by approximately 20 mm the cover layer (16a) of the first sandwich panel (12a) oriented towards the second sandwich panel (20a) on both sides of the second sandwich panel (20a).

16. Sandwich component assembly according to claim 10, characterized in that the layer of expanding adhesive (32; 32a) is provided in the form of a thin strip.

17. Sandwich component assembly according to claim 10, characterized in that each edge of the second sandwich panel (20a) connected to the first sandwich panel (12a) is butt-joined to the first sandwich panel (12a).

18. Sandwich component assembly according to claim 10, characterized in that the honeycomb cores (14, 22; 14a, 22a) are substantially planar.

19. Sandwich component assembly according to claim 10, characterized in that the honeycomb cores (14, 22; 14a, 22a) consist of synthetic resin-impregnated paper cells.

20. Sandwich component assembly according to claim 19, characterized in that the paper cells are reinforced with aramide fibers.

21. Sandwich component assembly according to claim 19, characterized in that the paper cells have a right-angled or hexagonal cross section.

22. Method for producing a sandwich component assembly (10) with an L-shaped element, comprising the steps:
providing a first honeycomb core (14) and a second honeycomb core (22) to be connected to the first honeycomb core (14),
arranging a layer of expanding adhesive (32) between an edge of the second honeycomb core (22) and the first honeycomb core (14),
arranging an inner cover layer (16) and an outer cover layer (18) on the first honeycomb core (14), and arranging an inner cover layer (26) and an outer cover layer (24) on the second honeycomb core (22), in such a manner that the outer cover layers (18, 24) and the inner cover layers (16, 26) overlap in the connection zone between first honeycomb core (14) and second honeycomb core (22), and
heat treating the assembly obtained, for connecting together and curing the first honeycomb core (14) and the second honeycomb core (22) and the cover layers (16, 18; 24, 26).

23. Method according to claim 22, characterized by the step of bringing tip the outer cover layer (18) of the first honeycomb core (14) into overlap with the outer cover layer (24) of the second honeycomb core (22).

24. Method according to claim 23, characterized in that the outer cover layer (18) of the first honeycomb core (14) is arranged over the outer cover layer (24) of the second honeycomb core (22).

25. Method according to claim 22, characterized by the step of bringing down the inner cover layer (26) of the second honeycomb core (22) into overlap with the inner cover layer (16) of the first honeycomb core (14).

26. Method according to claim 22, characterized by the step of chamfering the edges of the first honeycomb core (14) and of the second honeycomb core (22) oriented towards one another in the connection zone.

27. Method for producing a sandwich component assembly (10a) with a T-shaped element, comprising the steps:
providing a first honeycomb core (14a) and a second honeycomb core (22a) to be connected to the first honeycomb core (14a),
arranging a layer of expanding adhesive (32a) between an edge of the second honeycomb core (22a) and a side face of the first honeycomb core (14a),
arranging a cover layer (16a) on the side of the first honeycomb core (14a) which is oriented towards the second honeycomb core (22a), and arranging cover layers (24a, 26a) on both sides of the second honeycomb core (22a), in such a manner that the cover layers (24a, 26a) of the second honeycomb core (22a) overlap with the cover layer (16a) of the first honeycomb core (14a) in the connection zone between first honeycomb core (14a) and second honeycomb core (22a), and
heat treating the assembly obtained, for connection together and curing of the first honeycomb core (14a) and the second honeycomb core (22a) and the cover layers (16a; 24a, 26a).

28. Method according to claim 27, characterized by the step of bringing up the cover layer (16a) of the first honeycomb core (14a) into overlap with the cover layers (24a, 26a) of the second honeycomb core (22a).

29. Method according to claim 28, characterized in that the cover layers (24a, 26a) of the second honeycomb core (22a) are arranged over the cover layer (16a) of the first honeycomb core (14a).

30. Method according to claim 27, characterized by the step of arranging a reinforcing cover layer (34) between the layer of expanding adhesive (32a) and the first honeycomb core (14a) in overlap with the cover layer (16a) of the first honeycomb core (14a).

31. Method according to claim 22, characterized in that the heat treatment step is carried out in an autoclave.

32. Method according to claim 31, characterized in that the heat treatment step takes place with combined application of pressure below and above atmospheric.
